(19) United States
(12) Patent Application Publication
(10) Pub. No.: US 2003/0177902 A1
(43) Pub. Date: Sep. 25, 2003

(54) Water wash system and process for industrial painting operations

(76) Inventor: John M. Spangler, Peoria, IL (US)

Correspondence Address: CATERPILLAR INC., 100 N.E. ADAMS STREET, PATENT DEPT., PEORIA, IL, 616296490

(21) Appl. No.: 10/105,912

(22) Filed: Mar. 25, 2002

(51) Int. Cl. B01D 53/02

(52) U.S. Cl. 95/92; 96/108; 118/326; 118/603; 118/610

(57) ABSTRACT

A system and process for industrial painting operations is disclosed. The disclosed system and process includes entraining paint particles from a paint booth operation in a stream of air; directing the stream of air to an aqueous bath covered with a layer of small silica particles; encapsulating the paint particles present in the stream of air with the small silica particles; further cleansing the stream of air by removing residual paint particles and other unwanted compounds as the stream of air is directed through an exhaust system; and recycling the encapsulated paint particles remaining in the paint booth.

### TECHNICAL FIELD

This invention relates generally to an environmentally friendly system and process for industrial painting operations, and more particularly, to water wash system and process for both reclaiming over-spray paint and cleansing the air in an industrial painting operation.

### BACKGROUND

Spray painting either by a robot or human operator generates a large amount of over-spray waste. Even with the wide spread use of modem electrostatic spray technology about half of all paint purchased is wasted. Over-spray paint by-product generated in paint spraying operations takes the form of either a liquid sludge or semi-cured product embedded on a filter media. Many water-wash paint booth systems capture over-sprayed paint by using positive air pressure to force the particles into a cascading curtain of water. Over a period of time these particles of paint accumulate and form a sticky agglomeration of over-spray paint material in the bottom of the water-wash pit or sludge tank. The water-wash design, because of its' high efficiency and wet by-product characteristics, has faced substantial challenges with the promulgation of more restrictive landfill regulations. In addition, environmental regulations addressing the discharge of the air used in such painting operations are driving the need for improved industrial painting processes. It is thus becoming increasingly prohibitive, both economically and environmentally, to dispose of paint waste by-products as well as maintain and operate air discharge systems associated with industrial painting operations.

Paint reclamation techniques employed in many existing water-wash systems involve adding water-soluble poly-electrolytes to the water system of the water-wash spray booth to disperse paint droplets in the aqueous system. (See U.S. Pat. No. 3,515,575, issued Jun. 2, 1970 to Roger F. Arnold). This reference teaches that compounds containing various alkalis, wetting agents, absorbents, de-foamers and the like can be dissolved in the water to reduce tackiness of the paint waste product. However, significant problems relating to the ultimate disposal of the paint waste product as well as the maintenance of air discharge systems associated with painting operations still exist with such water-wash systems.

Recent advancements in paint reclamation processes are described in U.S. Pat. Nos. 5,684,053 issued Nov. 4, 1997 and 5,092,928 issued Mar. 3, 1992 to John Spangler. The disclosed processes both teach the use of hydrophobic fumed silica in de-tackification of over spray paint particles. The recovered encapsulated particles may be segregated and subsequently processed to form a desirable reconstituted paint material or paint additive. However, such disclosed systems are stand-alone paint reclamation systems and may require the installation of new paint booth configurations, at significant cost and do not address the air quality issues present in many industrial paint operations. What is needed therefore are cost-effective systems and processes that utilize existing water-wash paint booth configurations while achieving the enhanced paint reclamation feature of hydrophobic fumed silica and meeting the more stringent air discharge environmental regulations.

### SUMMARY OF THE INVENTION

The presently disclosed embodiment of the invention can be characterized as a process for reclaiming paint comprising the steps: (a) entraining paint particles in a stream of air; (b) directing the stream of air to an aqueous bath; (c) encapsulating the paint particles in small silica particles that are disposed on the top surface of the aqueous bath; (d) retaining the encapsulated paint particles and silica while directing the stream of air through an exhaust system; and (e) recycling the encapsulated paint particles.

Alternatively, the presently disclosed embodiment of the invention can be characterized as a process for cleansing air from a painting operation comprising the following steps: (a) entraining paint particles in a stream of air; (b) directing the stream of air to an aqueous bath; (c) encapsulating the paint particles in small silica particles that are disposed on the top surface of the aqueous bath; (d) retaining the encapsulated paint particles and silica in the aqueous bath while directing the stream of air to an exhaust system; and (e) cleansing the stream of air directing to the exhaust system.

Finally, the presently disclosed embodiment of the invention can be characterized as a system for industrial painting operations comprising a water wash paint booth; a layer of silica particles disposed on the aqueous bath of the water-wash paint booth, the silica particles adapted to encapsulate over-spray paint particles; a retaining mechanism for keeping the silica particles within a prescribed area on the aqueous bath; and an auxiliary air cleansing system for removing paint particles and other unwanted compounds remaining in the air stream.

### BRIEF DESCRIPTION OF THE DRAWINGS

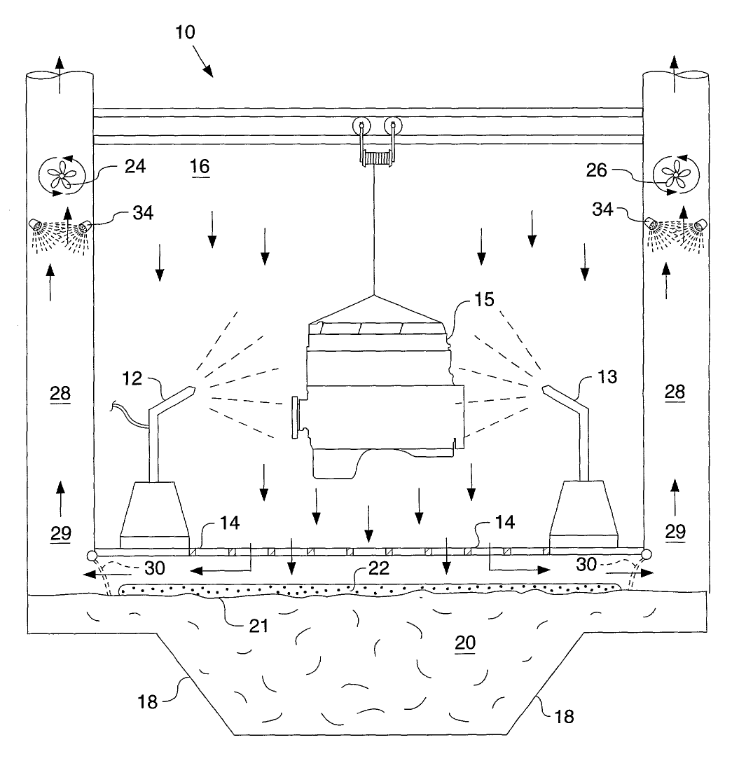

The above and other aspects, features and advantages of the present system and process for industrial paint operations will be more apparent from the following more particular description thereof, presented in conjunction with the following drawing, wherein FIG. 1 is a schematic diagram of present system and process for industrial paint operations.

### DETAILED DESCRIPTION

The following description is of the best mode presently contemplated for carrying out the invention. This description is not to be taken in a limiting sense but is made merely for the purpose of describing the general principals of the invention. The scope and breadth of the invention should be determined with reference to the claims.

A paint booth 10 adapted for use in industrial paint operations and suitable for carrying out a preferred embodiment of the present invention is depicted in FIG. 1. The illustrated paint booth 10 is a conventional down draft, water wash type paint spray booth having a paint application station disposed in the paint booth 10 and includes one or more spray guns 12,13 or other automated painting devices connected to a source of paint (not shown), the operation of which may be controlled automatically, by robot or human operator. As illustrated in the drawing, an article 15 to be painted is transported through or placed in the paint booth 10 by conventional means, including conveyors, stands, mounting or suspending apparatus, or other means known to those skilled in the art.

The paint booth 10 has an open metal grate floor 14 or the like separating the paint booth 10 into an upper paint spray chamber 16 and a lower sump or sludge tank 18. The paint booth 10 also includes a supply of water or an aqueous bath 20 within the sludge tank 18. The aqueous bath 20 includes a top surface 21 separated by a prescribed distance from the grate floor 14. A layer of hydrophobic fumed silica 22 is disposed on the top surface 21 of the aqueous bath 20 in an area immediately underneath the grate floor 14.

Exhaust fans 24,26 are disposed in one or more exhaust air conduits 28 and are in flow communication with the paint booth 10. The exhaust fans 24,26 provide for the movement of air out of the paint booth 10. Flow of air into the paint booth is typically accomplished via make up air system. The make-up air system forcibly introduces a volume of air via a plenum (not shown) into the upper paint spray chamber 16, through the metal grate floor 14 to the sludge tank 18. The flow of air continues out one or more exhaust air conduits 28 via one or more exits 29 that lead to the exhaust air conduits 28 and ultimately to the external environment. The exits 29 are preferably disposed adjacent to the sludge tank 18 and proximate the top surface 21 of the aqueous bath 20. Proximate the exits 29 are one or more paint retaining devices, shown in the preferred embodiment as a cascading curtain of water 30 that drops from near the grate floor 14 into the aqueous bath 20. Also shown in the drawing is a water shower or water spray system 34 disposed in the exhaust air conduits 28 that operates to spray water within the exhaust air conduits 28 so as to scrub or otherwise remove any paint particles or other unwanted particulates remaining in the air stream as the air stream passes through the exhaust air conduits 28.

As the air stream flows through the upper paint spray chamber 16 of paint booth 10, paint over-spray is entrained in the air stream. Such paint over-spray particles or compounds are directed or transported with the flowing air stream from the upper paint spray chamber 16 of the paint booth 10 and through the open metal grate floor 14. After passing through the grate floor 14, the air stream containing the over-spray paint particles or droplets are directed into sludge tank 18. Air stream flow volume through the paint booth 10 is preferably limited to about 50-100 cubic feet per second. Such a flow profile is sufficient to cause the over-spray paint particles and droplets carried by the air stream to fall from the air stream into contact with the layer of hydrophobic fumed silica 22 on the top surface 21 of the aqueous bath 20. Such velocity profile, however, does not substantially interfere in the painting operations nor causes excessive disruption of the silica layer 22. The optimum velocity of the air stream at which the over-spray paint particles or droplets will most effectively gravitationally separate from the air stream is a function of the mass and size of the over-spray particles and droplets, which may be determined empirically for each industrial painting operation employing the above-described technology.

As entrained paint particles or droplets pass through the grate floor 14, most of the paint particles and droplets are drawn into contact with the layer of hydrophobic fumed silica 22. The hydrophobic fumed silica particles 22 float on the top surface 21 of the aqueous bath 20. In the preferred embodiment of the present invention, a layer of hydrophobic fumed silica particles 22 having a particle size of about 16 nm and a BET surface area of about 110 m2/g, is formed on the top surface 21 of the aqueous bath 20. Hydrophobic fumed silica having these characteristics is commercially available from Degussa AG, Frankfurt, W. Germany, under the trade name AerosilÒ R972. When a paint particle or droplet comes in contact with the hydrophobic fumed silica layer 22, the smaller silica particles attach to or coat the surface of the paint particle or droplet. Sufficient attachment of a plurality of silica particles to the paint particle or droplet eventually leads to encapsulation of the paint particle or droplet with silica particles. The encapsulation of the paint particle or droplet by the plurality of silica particles operates to de-tackify the paint particle or droplet. Moreover, the encapsulated and de-tackified particles have a tendency to agglomerate which leads to easier collection, handling, and recovery of the paint.

The layer of hydrophobic fumed silica 22 is preferably formed by depositing bulk silica directly on the top surface 21 of the aqueous bath 20. Because of the low density and non-wetting characteristics of the hydrophobic fumed silica, the silica particles 22 float on the top surface 21 of the aqueous bath 20 and do not tend to settle or intermix with the water. In addition, because the hydrophobic fumed silica particles 22 have an amorphous conformation, the silica particles 22 spread evenly on the top surface 21 of the aqueous bath 20 and form a layer having a substantially uniform thickness. In a demonstration of the present system and process, 20 kg of hydrophobic fumed silica was disposed on an aqueous bath over a surface area of about 53.5 m2. the silica particles effectively encapsulated paint particles for a period of about 3 weeks during which 568 liters of paint was sprayed in the booth producing roughly 170 liters of paint over-spray. Thus, it is estimated that 1.0 kg of hydrophobic fumed silica is sufficient to treat about 8.5 liters of paint over-spray.

In the preferred embodiment, the cascading curtain of water 30 operates as a barrier to keep the layer of hydrophobic fumed silica 22 confined to a prescribed area underneath the grate floor 14 and generally prevents the silica particles from migrating toward the exits 29 and exhaust air conduits 28. Alternatively, flow baffles could be positioned so as to keep the hydrophobic fumed silica particles properly positioned. Because it is desirable to limit the amount of paint particles and droplets that come into first contact with the aqueous bath 20, the use of the flow baffles and the cascading curtain of water 30 or both, operates to keep the hydrophobic fumed silica particles 22 confined to a prescribed area. Confining the silica particles 22 to a prescribed area increases the likelihood that the over-spray paint particles or droplets first contact the silica particles 22 and are encapsulated or coated in silica before reaching the top surface 21 of the aqueous bath 20 and thereby minimizing the paint particles intermixing with the aqueous bath 20.

The small portion of paint over-spray particles remaining in the air stream after passing through the grate floor 14 and sludge tank 18 are effectively washed from the air stream by the cascading curtain of water 30 proximate the exit 29. Finally, a water spray or water shower 34 further traps escaping paint particles within the exhaust air conduits 28. Paint particles removed by the water curtain are carried back into the aqueous bath 20. Many of the washed paint particles eventually return to the top surface 21 of the aqueous bath 20 where they come in contact with, and are encapsulated by the hydrophobic fumed silica particles 22 disposed on the top surface 21 of the aqueous bath 20.

Advantageously, this cleansing process of the water curtain 30 and prevent paint over-spray from accumulating in the exhaust air conduits 28 and any air baffles present in the exhaust system while concurrently retaining the silica particles in the ideal position. This in turn, optimizes the efficiency of paint encapsulation within the silica particles and minimizes the paint booth cleaning requirements and associated maintenance costs. Likewise, this cleansing process prevents many other unwanted compounds, including paint over-spray, from being emitted into the external atmosphere.

The preferred paint reclamation or paint recovery process is initiated with the de-tackification of the paint particles and droplets using the silica particles 22. The encapsulated paint particles and droplets typically remain buoyant in the aqueous bath for about one week or more, during which time the encapsulated paint particles and droplets can be removed and collected from sludge tank 18 by a skimming process or other well known collection processes. If the encapsulated paint particles and droplets are not removed from the top surface 21 of the aqueous bath 20 in a timely manner, they may settle to the bottom of sludge tank 18. In such case, they may be removed and collected from the bottom of the sludge tank 18 at a later time by conventional mechanical means, well known to those skilled in the art.

Once collected, de-tackified paint over-spray (and any of the aqueous solution collected therewith) is preferably transferred to a processing reservoir and optionally, conditioned with various materials to remove bacteria and otherwise aid in the recycling process. To remove the bacteria a biocide or other solution such as hydrogen peroxide is added to the processing reservoir to kill the bacteria. If necessary, the mixture (i.e. aqueous bath solution and de-tackified paint over-spray) is then transferred to a de-watering device for removal of the water. The remaining material is subsequently dried to a moisture content of less than about 5 percent, and preferably a moisture content of less than about 2 percent. The dried, de-tackified, paint over-spray is then particulized to a size less than about 20 microns and dissolved in an appropriate solvent. The process for transferring, conditioning, de-watering, drying, and particulizing (e.g. milling) etc. are now well known to those persons skilled in the art by virtue of the disclosures in U.S. Pat. No. 5,684,053 and other publications.

As indicated above, various materials can be added to the recycling materials (paint and silica) during the aforementioned process to aid the processing of the material as well as to complete the recycled paint product. In addition, specific additional ingredients such as binders, plasticizers, stabilizers, pigments, flow control agents, etc. can be included to restore properties to the recycled paint product that may have been lost during the original spraying operation.

### INDUSTRIAL APPLICABILITY

This present embodiment of the invention is ideally suited for industrial painting operations, including industrial painting operations in the transportation, aerospace, and industrial equipment sectors where equipment, components and materials are painted for aesthetic reasons as well as basic surface protection of the articles. More importantly, the advantages of the present system and process, both in terms of less waste material from painting operations, less maintenance of painting booths and associated equipment, as well as the cleaner exhaust air should improve both the economic and environmental impacts of many industrial painting operations.

As described above, the presently disclosed system and process for industrial painting operations includes three broad phases including the collection or encapsulation of over-spray paint particles or droplets, the cleansing of the paint booth exhaust air, and the reclamation or recycling of the collected paint particles. Advantageously, the present embodiment integrates the existing water-wash systems with the improved collection or encapsulation techniques demonstrated by hydrophobic fumed silica 22. Thus, improvement to industrial painting operations can be achieved without the need to purchase new paint booth configurations. Still further, the present embodiments have yielded superior results by integrating a secondary cleansing action, namely the cascading curtain of water 30 which can be easily integrated into many water-wash systems.

After encapsulation, the silica encapsulated paint particles and droplets can be processed into a high quality re-useable paint product. Thus, the cost of disposal for waste material from many industrial painting operations can be greatly reduced. In addition, the recycled paint products or materials can offset the cost of new material or can be sold to third party processors to generate a source of revenue. Advantageously, the hydrophobic fumed silica particles 22 used in the preferred embodiments are not deleterious to a recycled paint product formed of the encapsulated particles since silica is often used as an effective additive to paint compositions. For example, silica is often used as a thixotropic agent in decorative coatings, or added to improve the suspension behavior of pigments, as well as corrosion protection characteristics in various primer and industrial coatings.

From the foregoing, it can be seen that the disclosed embodiment provides a system and process for industrial paint operations. While the embodiment herein disclosed has been described by means of specific components and methods or processes associated therewith, numerous changes, modifications, and variations could be made thereto by those skilled in the art without departing from the scope of the invention as set forth in the claims.

What is claimed is:

1. A process for reclaiming paint comprising the steps of:
entraining paint particles in a stream of air;
directing said stream of air to an aqueous bath, said aqueous bath having a surface and including silica particles on said surface of said aqueous bath;
encapsulating said paint particles in said silica particles;
retaining said silica particles and encapsulated paint particles in said aqueous bath;
directing said stream of air away from said aqueous bath; and
recovering said encapsulated paint particles.

2. The process of claim 1 wherein said silica particles are hydrophobic fumed silica particles.

3. The process of claim 1 wherein the step of retaining said encapsulated paint particles within said aqueous bath includes providing a curtain of water proximate an exit of said aqueous bath, said curtain of water retaining said silica particles and encapsulated paint particles in a prescribed area of said aqueous bath.

4. The process of claim 1 wherein the step of retaining said encapsulated paint particles within said aqueous bath includes providing a barrier proximate an exit of said aqueous bath, said barrier preventing said silica particles and said encapsulated paint particles from exiting said aqueous bath.

5. The process of claim 1 further including the step of cleansing said stream of air upon exit of said aqueous bath.

6. The process of claim 1 further comprising the step of reclaiming said paint particles from said recovered encapsulated paint particles.

7. The process of claim 6 wherein the step of reclaiming said paint particles further includes the steps of:
conditioning said paint particles;
drying said paint particles to a moisture content less than about 5 percent; and
particulizing said paint particles to a size less than about 20 microns.

8. A process for cleansing air from a painting operation, said process comprising the steps of:
entraining paint particles present during said painting operation in a stream of air;
directing said paint entrained stream of air to an aqueous bath, said aqueous bath having a surface and including hydrophobic fumed silica on said surface of said aqueous bath;
encapsulating said paint particles in said hydrophobic fumed silica;
retaining said encapsulated paint particles within said aqueous bath;
directing said stream of air from said aqueous bath via an exit; and
further cleansing said stream of air.

9. The process of claim 8 wherein the step of retaining said encapsulated paint particles within said aqueous bath includes providing a curtain of water proximate said exit of said aqueous bath, said curtain of water retaining said hydrophobic fumed silica and encapsulated paint particles in a prescribed area on said aqueous bath.

10. The process of claim 8 wherein the step of retaining said encapsulated paint particles within said aqueous bath includes providing a barrier proximate an exit of said aqueous bath, said barrier preventing said hydrophobic fumed silica and said encapsulated paint particles from exiting said aqueous bath.

11. The process of claim 8 wherein the step of cleansing said stream of air includes passing said stream of air through a curtain of water proximate said exit of said aqueous bath.

12. The process of claim 8 wherein the step of cleansing said stream of air includes scrubbing said stream of air with a water spray upon exit of said aqueous bath.

13. An industrial painting system comprising:
a water-wash paint booth including an upper paint spray chamber, a grate floor, a sludge tank, and an air intake system having a stream of air;
an exhaust system including an exhaust air conduit and at least one exhaust fan, said exhaust system in flow communication with said air intake system;
an aqueous bath disposed in said sludge tank, said aqueous bath having a top surface;
a layer of silica particles disposed on said top surface of said aqueous bath, said silica particles adapted to encapsulate over-spray paint particles entrained in said stream of air;
a retaining mechanism disposed proximate an exit of said sludge tank, said retaining mechanism adapted for keeping said silica particles and encapsulated paint particles within a prescribed area on said aqueous bath under said grate floor; and
an auxiliary cleansing system for removing paint particles and other unwanted compounds remaining in said air stream.

14. The system of claim 13 wherein said retaining mechanism is a curtain of water.

15. The system of claim 13 wherein said auxiliary cleansing system mechanism is a curtain of water.
